(19) United States
(12) Patent Application Publication
(10) Pub. No.: US 2015/0022738 A1
(43) Pub. Date: Jan. 22, 2015

(54) TOUCH PANEL AND METHOD OF FABRICATING A MESH OF TOUCH PANEL

(71) Applicant: WINTEK CORPORATION, Taichung City (TW)

(72) Inventors: Rone-Hwa Chou, Nantou County (TW); Chong-Yang Fang, Taichung City (TW); Chong-Wei Li, Changhua County (TW); Fa-Chen Wu, Taichung City (TW); Cheng-Chieh Hung, Taichung City (TW)

(21) Appl. No.: 14/333,525

(22) Filed: Jul. 17, 2014

(30) Foreign Application Priority Data
Jul. 17, 2013 (TW) 102125614

(51) Int. Cl. G06F 3/041

(52) U.S. Cl. CPC G06F 3/041
USPC 349/12; 29/428

(57) ABSTRACT

A touch panel includes a sensing electrode. The sensing electrode includes a plurality of mesh units pieced together with others. Each of the mesh units is different from at least one of adjacent mesh units in shape. Each of the mesh units has a plurality of side edges connected with one another. At least two side edges of each of the mesh units are different in length.

### BACKGROUND OF THE INVENTION

1. Field of the Invention

The present invention relates to a touch panel and a method of fabricating a mesh of touch panel, and more particularly, to a touch panel having an irregular mesh and a method of fabricating the irregular mesh.

2. Description of the Prior Art

In recent years, touch sensing technologies have developed flourishingly. There are many consumer electronics in combination with touch sensing functions, such as mobile phones, GPS navigator system, tablet PCs, personal digital assistants (PDA), and laptop PC. Those consumer electronics are mainly characterized by integrating original display functions with touch sensing functions, so as to perform as a touching display device. There are many diverse technologies of touch panel, such as the resistance touch technology, the capacitive touch technology and the optical touch technology which are the main touch technologies in use. In conventional resistance touch technology or capacitive touch technology, the sensing electrode for detecting touching signals are usually made of indium tin oxide (ITO), in order to avoid the interference to display functions. However, due to the high electrical resistivity of the indium tin oxide in comparison with metal conductive materials, the sensing electrode made of indium tin oxide may lead to higher integrated resistance and be poor in reaction rate. Therefore, a metal mesh consisted of interweaved metal wires are developed in related arts to replace indium tin oxide, thereby using the metal mesh to form the sensing electrode for increasing the reaction rate. Conventional metal mesh pattern is formed by piecing together some regular patterns, such as regular hexagon or square. However, while attaching these metal meshes to a display panel, it is easy to result in Moiré effect if the side edges of each metal mesh and the pixel electrodes are similar in length or in size. Therefore, the entire visible quality will be affected.

### SUMMARY OF THE INVENTION

It is one of the objectives of the present invention to provide a touch panel and a method of fabricating a mesh of a touch panel. Mesh units in different shapes are used to form sensing electrodes so as to improve problems caused by moiré effect between the touch panel and the pixel electrodes.

To achieve the purpose described above, a preferred embodiment of the present invention provides a touch panel comprising a sensing electrode. The sensing electrode comprises a plurality of mesh units pieced together with each other, and each of the mesh units is different from at least one of adjacent mesh units in shape. Each of the mesh units has a plurality of side edges connected with one another and at least two of the side edges of each mesh unit are different in length.

To achieve the purpose described above, a preferred embodiment of the present invention provides a method of fabricating a mesh of touch panel comprising following steps. First of all, a first mesh pattern unit is provided. The first mesh pattern unit comprises a plurality of first side edges connected with one another, and at least two of the first side edges are different in length. Next, a plurality of second mesh pattern units is drawn outward based on the first side edges of the first mesh pattern unit. Each of the first side edges also performs as a side edge of each second mesh pattern unit, and the first mesh pattern unit and at least one of the second mesh pattern units are different in shape. Then, the first mesh pattern unit and the second mesh pattern units are converted to a mesh.

In the method of fabricating a mesh of a touch panel according to the present invention, irregular mesh pattern units are drawn outward according to one irregular mesh pattern unit, and those irregular mesh pattern units are then converted to form a mesh of a touch panel. Also, the touch panel of the present invention comprises a sensing electrode made of those irregular mesh units. Those irregular mesh units pieced together with each other are used to improve problems caused by moiré effect between the touch panel and the pixel electrodes. Thus, a preferable visible effect can be achieved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1, FIG. 2, FIG. 3 and FIG. 4 are diagrams illustrating a method of fabricating a mesh of touch panel according to one preferred embodiment of the present invention.

FIG. 5 is a diagram illustrating a touch panel according to a first preferred embodiment of the present invention.

FIG. 6 is a diagram illustrating a touch panel according to a second preferred embodiment of the present invention.

FIG. 7 is a diagram illustrating a touch panel according to a third preferred embodiment of the present invention.

FIG. 8 is a diagram illustrating a touch panel according to a fourth preferred embodiment of the present invention.

FIG. 9 is a diagram illustrating a touch panel according to a fifth preferred embodiment of the present invention.

FIG. 10 is a diagram illustrating a touch panel according to a sixth preferred embodiment of the present invention.

FIG. 11 is a diagram illustrating a mesh according to another preferred embodiment of the present invention.

FIG. 12 is a diagram illustrating a mesh according to further another preferred embodiment of the present invention.

### DETAILED DESCRIPTION

To provide a better understanding of the present invention to users skilled in the technology of the present invention, preferred embodiments are detailed as follows. The preferred embodiments of the present invention are illustrated in the accompanying figures to clarify the contents and effects to be achieved.

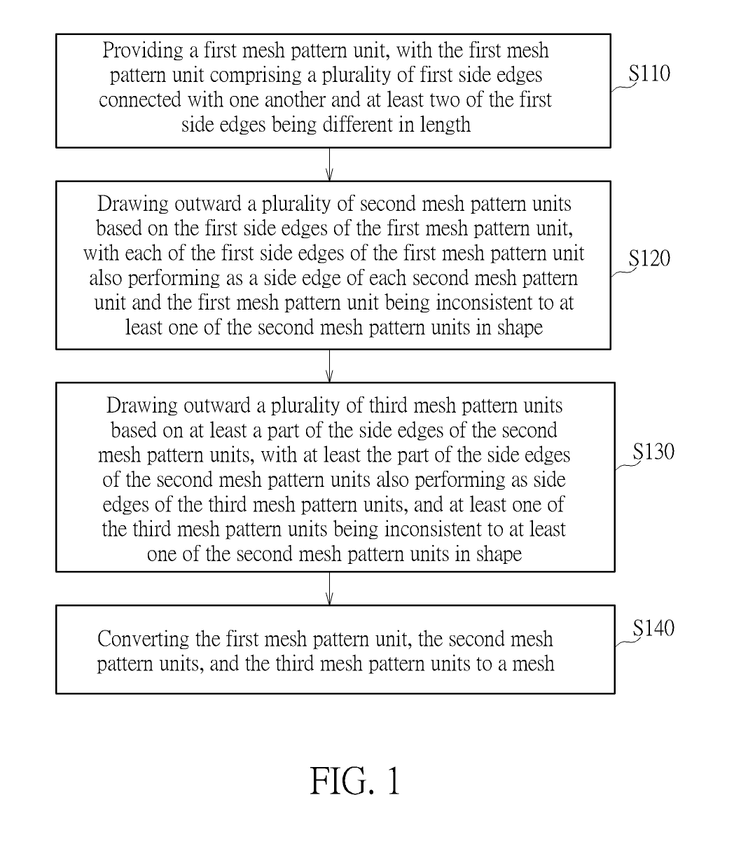

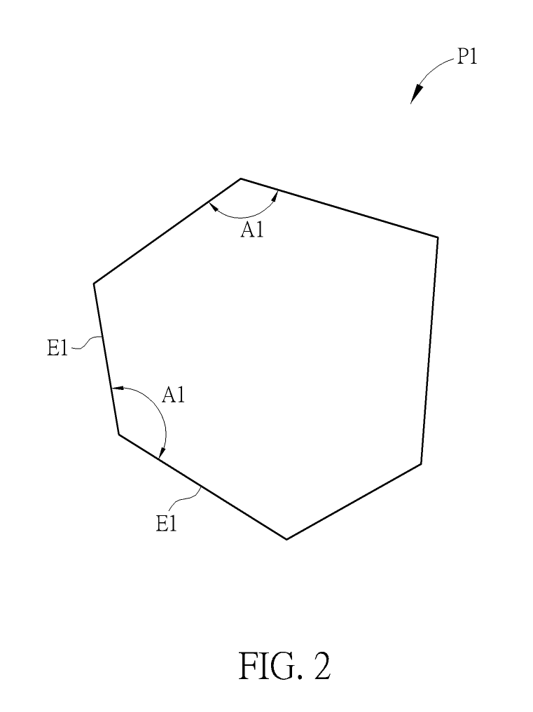

Please refer to FIGS. 1-4. FIGS. 1-4 are diagrams illustrating a method of fabricating a mesh of a touch panel according to one preferred embodiment of the present invention, wherein FIG. 1 is a flow chart. Please note that the figures in the present invention are only for illustration and the scale thereof can be further modified according to different design considerations. As shown in FIG. 1 to FIG. 4, one preferred embodiment of the present invention provides a method of fabricating a mesh of a touch panel, and which comprises following steps. First of all, step S110 is performed by providing a first mesh pattern unit P1, wherein the first mesh pattern unit P1 comprises a plurality of first side edges E1 connected with one another, and at least two of the first side edges E1 are different in length. Preferably, the first mesh pattern unit P1 comprises a polygon but is not limited thereto. In other preferred embodiments of the present invention, the first mesh pattern unit P1 can also comprise an irregular mesh unit having curved side edges. In other words, each of the first side edges E1 can include a straight line or a curved line. In the present embodiment, the first mesh pattern unit P1 is an irregular polygon, and the first mesh pattern unit P1 does not include any regular polygon. Precisely speaking, in the first mesh pattern unit P1, an amount of the first side edges E1 is preferably equal to three or more than three and not greater than eight, but not limited thereto. Namely, the first mesh pattern unit P1 can include irregular triangle, irregular quadrangle, irregular pentagon, irregular hexagon, irregular heptagon, or irregular octagon. Also, at least two of the first side edges E1 in the first mesh pattern unit P1 are different in length, and the longer one among the two first side edges E1 is more than 5% longer than the other one, but not limited thereto. On the other side, the first mesh pattern unit P1 has a plurality of internal angles A1, at least two of the internal angles A1 are different in degree, and the greater one among the two internal angles A1 is more than 5% greater than the other one, but not limited thereto.

Next, as shown in FIG. 1 and FIG. 3, step S120 is performed by drawing outward a plurality of second mesh pattern units P2, and each of the second mesh pattern units P2 is drawn on the basis of one of the first side edges E1 of the first mesh pattern unit P1. Each of the first side edges E1 of the first mesh pattern unit P1 also performs as a side edge E2 of each second mesh pattern unit P2, and the first mesh pattern unit P1 is different from at least one of the second mesh pattern units P2 in shape. Namely, the first mesh pattern unit P1 shares the same side edges with adjacent second mesh pattern units P2 respectively. Additionally, the second mesh patterns P2 of the present embodiment are preferably in consistent to each other in shape and each of the second mesh pattern unit P2 is also different from the first mesh pattern unit P1 in shape. Preferably, the second mesh pattern units P2 comprise a polygon, but not limited thereto. In other preferred embodiments of the present invention, the second mesh pattern units P2 can also comprises an irregular mesh unit having curved side edges. In the present embodiment, each of the second mesh pattern units P2 is an irregular polygon, which means at least two side edges E2 of each second mesh pattern units P2 are different in length. Since the amount of the side edges, the differences of length between the side edges, as well as the differences of degree between the internal angles in the second mesh pattern units P2 are all similar to those of the first mesh pattern unit P1, it will not be further detailed herein. Please note that, the first mesh pattern unit P1 and at least one of the second mesh pattern units P2 are different in aperture area, and the aperture area of the greater one among these two is more than 5% greater than the aperture area of the other one. In other words, among those mesh patterns, the first mesh pattern unit P1 and each second mesh pattern unit P2 are preferably different in shape.

Then, as shown in FIG. 1 and FIG. 3, step S130 is performed by drawing outward a plurality of third mesh pattern units P3, and each of the third mesh patterns P3 is drawn on the basis of at least one of the side edges E2 of the second mesh pattern units P2. At least one of the side edges E2 of the second mesh pattern units also performs as a side edge E3 of the third mesh pattern units P3, and at least one of the third mesh pattern units P3 is different from at least one of the second mesh pattern units P2 in shape. Preferably, the third mesh pattern units P3 comprise a polygon, but not limited thereto. In other preferred embodiments of the present invention, the third mesh pattern units P3 can also comprises an irregular mesh unit having curved side edges. In the present embodiment, each of the third mesh pattern units P3 is an irregular polygon, which means at least two side edges E3 of each third mesh pattern units P3 are different in length. Since the amount of the side edges, the differences of length between the side edges, as well as the differences of degree between the internal angles in the third mesh pattern units P3 are all similar to those of the aforementioned first mesh pattern unit P1, it will not be further detailed herein. Through repeated performing steps similar to the aforementioned step S120 and step S130, a mesh pattern PX as shown in FIG. 3 can be obtained. In other words, the mesh pattern PX consists of said mesh pattern units in irregular polygon. The mesh pattern PX is then used to fabricate a photomask (not shown in the drawings), and the photomask is used for patterning a conductive material layer, such as a metal layer (not shown in the drawings), to form a mesh 120M of a touch panel 100 on a first substrate 111 as shown in FIG. 4. Therefore, in step S140, the first mesh pattern unit P1, the second mesh pattern units P2, and the third mesh pattern units P3 are converted to the mesh 120M. The mesh 120M of the touch panel in the present invention are preferably made of metal material or other suitably conductive materials. The aforementioned metal material includes at least one of aluminum, copper, silver, chromium, titanium and molybdenum, a composition or an alloy of aluminum, copper, silver, chromium, titanium and molybdenum, but not limited thereto. The conductive material includes a conductive particle, a carbon nanotube or a silver nanowire, but not limited thereto. The mesh 120M consists of a plurality of mesh units 120P. Preferably, the mesh units 120p comprise a metal mesh unit, but not limited thereto. In other words, each of the mesh units 120P includes at least one of aluminum, copper, silver, chromium, titanium and molybdenum, a composition or an alloy of aluminum, copper, silver, chromium, titanium and molybdenum, a conductive particle, a carbon nanotube, a silver nanowire or other suitably conductive materials. Each of the mesh unit 120P is corresponding to one of the irregular mesh patent units of the mesh pattern PX. In other words, the patterns of the mesh 120M can be optionally corresponding to at least one part of the patterns of the mesh pattern PX according to practical requirement. Therefore, the mesh 120M can only consist of the first mesh pattern unit P1 and the second mesh pattern units P2. In other words, the mesh 120M is fabricated right after step S120 by directly converting the first mesh pattern unit P1 and the second mesh pattern units P2 to the mesh 120M. Probably, the mesh 120M can also be fabricated by converting the first mesh pattern unit P1, the second mesh pattern units P2, the third mesh pattern units P3 and other mesh patent units in irregular polygon extended therefrom.

In the mesh 120M, each of the mesh units 120 is different from at least one of adjacent mesh units 120P in shape. Preferably, the mesh units 120P comprise a polygon mesh unit, but not limited thereto. In other preferred embodiments of the present invention, the mesh pattern unit 120P can also comprise an irregular mesh unit having curved side edges. Each of the mesh units 120P comprises a plurality of side edges E connected with one another, and at least two of the side edges E of each mesh unit 120P are different in length. Furthermore, each of the side edges E can include a straight line or a curved line. An amount of the side edges E in each mesh unit 120P is equal to three or more than three and not greater than eight, but not limited thereto. Namely, each of the mesh units 120P can include irregular triangle, irregular quadrangle, irregular pentagon, irregular hexagon, irregular heptagon, irregular octagon or other irregular polygons. Each of the mesh units 120P are pieced together with each other, and one side edge E of each mesh unit 120P also performs as a side edge E of one adjacent mesh unit 120P. In other words, each of the mesh unit 120P shares a same side edge with each adjacent mesh unit 120P. At least two side edges E of each mesh unit 120P are different in length, and the longer one among the two side edges E is more than 5% longer than the other one. Also, each of the mesh units 120P comprises a plurality of internal angles A, at least two of the internal angles A are different in degree, and the greater one among the two internal angles A is more than 5% greater than the other one, but not limited thereto. In other words, the side edges E and the internal angles A of each mesh unit 120P are preferably arranged in a random manner, but not limited thereto. Please note that, each of the mesh units 120P and at least one of adjacent mesh units 120P are different in aperture area, and the aperture area of the greater one among these two is more than 5% greater than the aperture area of the other one. In the present invention, a required amount of the mesh units 120P can be optionally disposed on the touch panel according to practical requirement. Therefore, in one touch panel, each of the mesh units 120P can be different from each other in shape, but the present invention is not limited thereto. In other preferred embodiments of the present invention, a plurality of mesh pattern units (not shown in FIG. 4) consisted of a part of the mesh units 120P can be optionally performed according to practical requirement, and the mesh 120M is then formed with the mesh pattern units pieced together with each other.

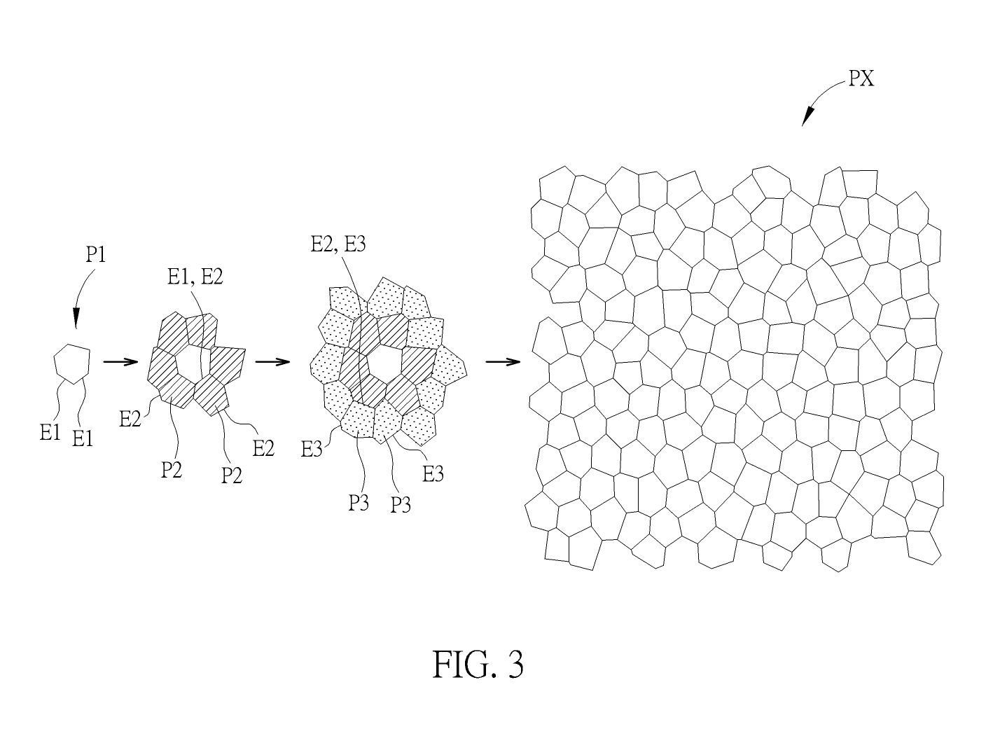

As shown in FIG. 4 and FIG. 5, FIG. 5 is a diagram illustrating a touch panel according to a first preferred embodiment of the present invention, and FIG. 4 can be regarded as a diagram illustrating a partial enlargement of the touch panel as shown in FIG. 5. As shown in FIG. 4 and FIG. 5, the present embodiment provides a touch panel 100 comprising a sensing electrode 120. The sensing electrode 120 comprises a plurality of mesh units 120P pieced together with each other (the mesh unit 120P referring to an area surrounding by a dotted line as shown in FIG. 4). Since detailed features of each mesh unit 120P has been fully described in the aforementioned paragraphs, it will not be further detailed herein. Please note that, the touch panel 100 may further comprise a first substrate 111, and the sensing electrode 120 is disposed on the first substrate 111. The first substrate 111 can include a glass substrate, a cover lens, a plastic substrate, a flexible cover lens, a flexible plastic substrate, a thin glass substrate, or a substrate of a display device, wherein the aforementioned cover lens has a decoration layer 130 disposed on at least one side thereof. The substrate of the display device as mentioned above can comprise a color filter substrate, an active matrix array substrate, or an encapsulation substrate of an organic light-emitting display device, but not limited thereto. In the present embodiment, the sensing electrode 120 can include a plurality of sub electrodes 120S and a plurality of connection portions 120C, and the connection portions 120C is electrically connected to corresponding sub electrodes 120S respectively. Each of the sub electrodes 120S are disposed on the first substrate 111 and electrically isolated from each other so as to perform a self-capacitance touching sensing, but not limited thereto. Please note that, each of the sub electrodes 120S, each of the connection portions 120C or each of the sub electrodes 120S and the connection portions 120C consist of at least one part of the mesh units 120P. In other words, both of each sub electrodes 120S and each connection portions 120C can optionally consist of the mesh units 120P according to practical requirements, and what is needed is disconnecting the mesh units 120P at particular site while defining each of the sub electrodes 120S and each of the connection portions 120C. Therefore, the related fabrication process can be simplified accordingly, but the present invention is not limited thereto.

Accordingly, while attaching the sub electrodes 120S, the connection portion 120C or both of the sub electrodes 120S and the connection portion 120C consisted of the mesh units 120P to a display pixel (not shown in the drawings) having displaying function, since each mesh unit 120P consists of different irregular polygons pieced together, the problems caused by moiré effect can be successfully avoided, so as to achieve improved visible effect.

The following description will detail the different embodiments of the touch panel of the present invention. To simplify the description, the following description will detail the dissimilarities among the different embodiments and the identical features will not be redundantly described. In order to compare the differences between the embodiments easily, the identical components in each of the following embodiments are marked with identical symbols.

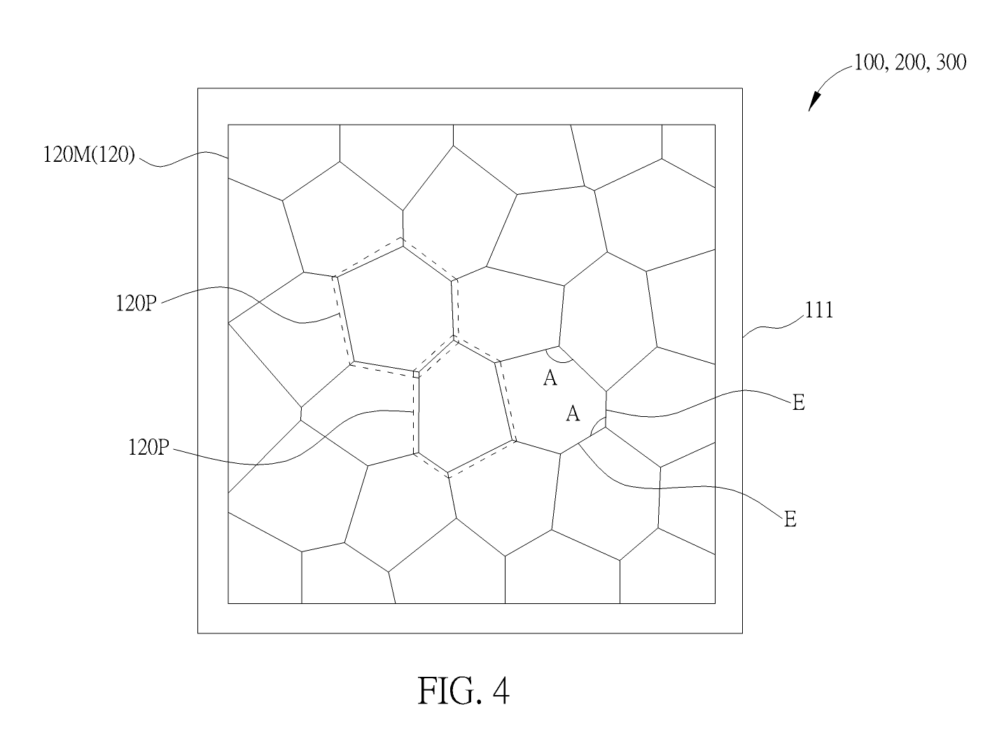

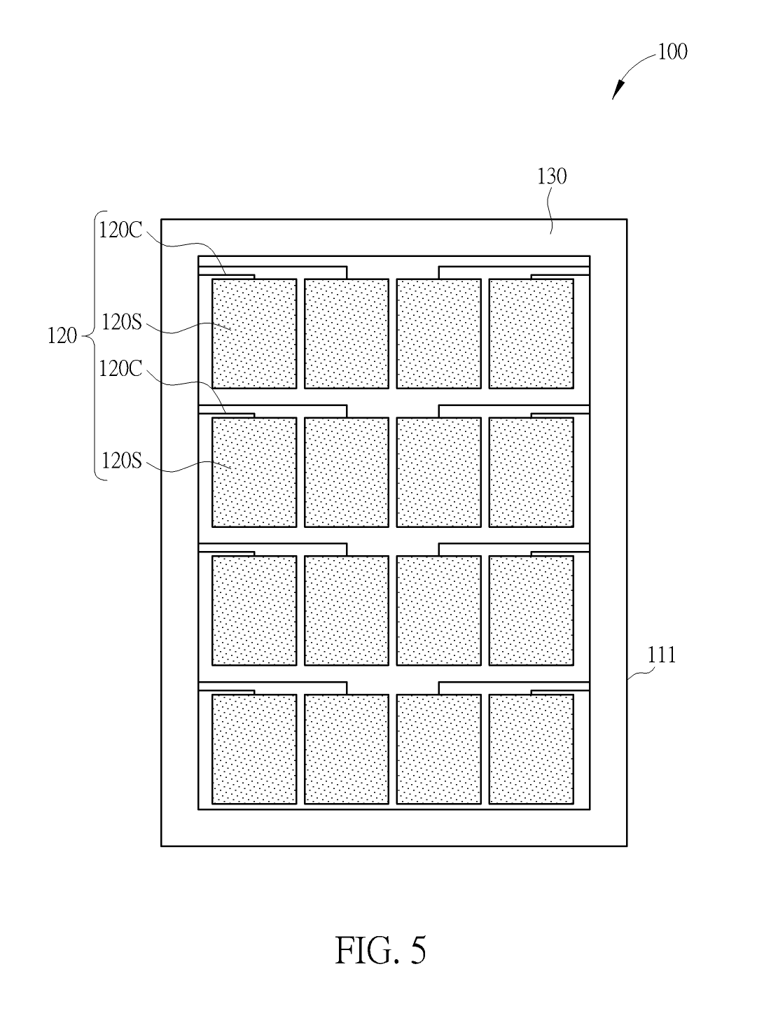

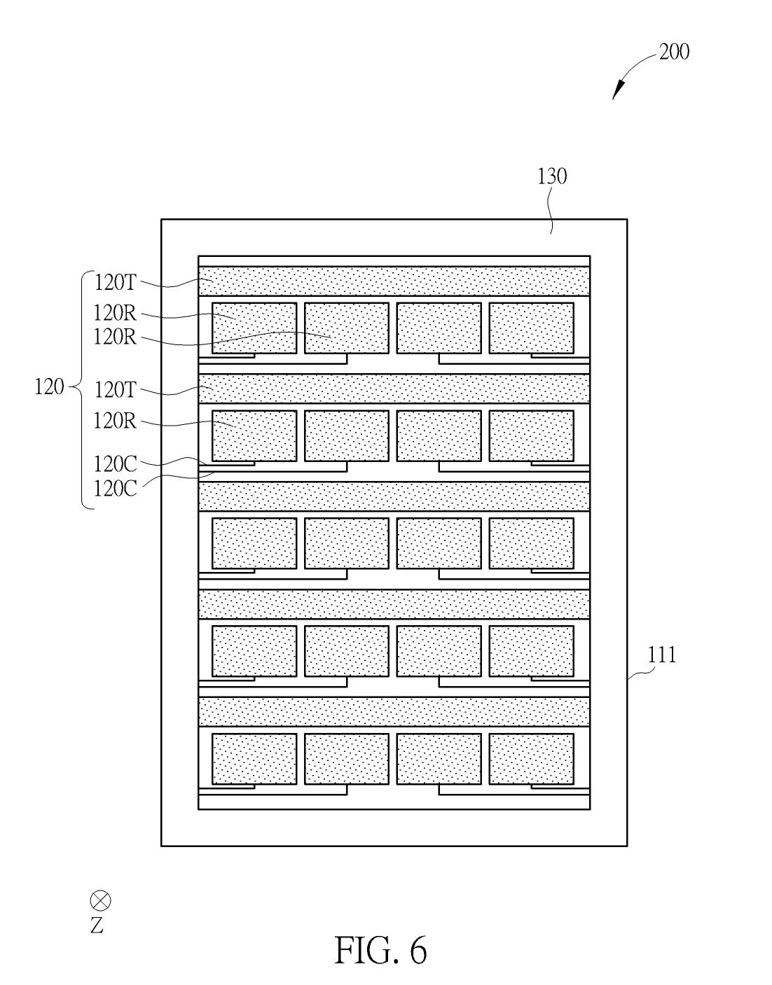

As shown in FIG. 4 and FIG. 6, FIG. 6 is a diagram illustrating a touch panel according to a second preferred embodiment of the present invention, and FIG. 4 can be regarded as a diagram illustrating a partial enlargement of the touch panel as shown in FIG. 6. As shown in FIG. 4 and FIG. 6, the present embodiment provides a touch panel 200, and which is characterized in that the sensing electrode 120 of the present embodiment comprises a plurality of signal transmission electrodes 120T, a plurality of signal receiving electrodes 120R and a plurality of connection portions 120C. Each of the connection portions is electrically connected to corresponding signal transmission electrodes 120T or signal receiving electrodes 120R. Each of the signal transmission electrodes 120T and each of the signal receiving electrodes 120R are disposed on the first substrate 111 and electrically isolated from each other, to perform mutual-capacitance touching sensing, but not limited thereto. Please noted that, each of the signal transmission electrodes 120T, each of the signal receiving electrodes 120R, each of the connection portions 120C or each of all aforementioned electrodes consists of at least one part of the mesh units 120P (the mesh unit 120P referring to an area surrounding by a dotted line as shown in FIG. 4), in order to improve the problems caused by moiré effect. In other words, each signal transmission electrode 120T, each signal receiving electrode 120R and each connection portion 120C can optionally consist of the mesh units 120P according to practical requirements, and what is needed is disconnecting the mesh units 120P at particular site while defining each signal transmission electrode 120T, each signal receiving electrode 120R and each connection portion 120C. Therefore, the related fabrication process can be simplified accordingly, but the present invention is not limited thereto.

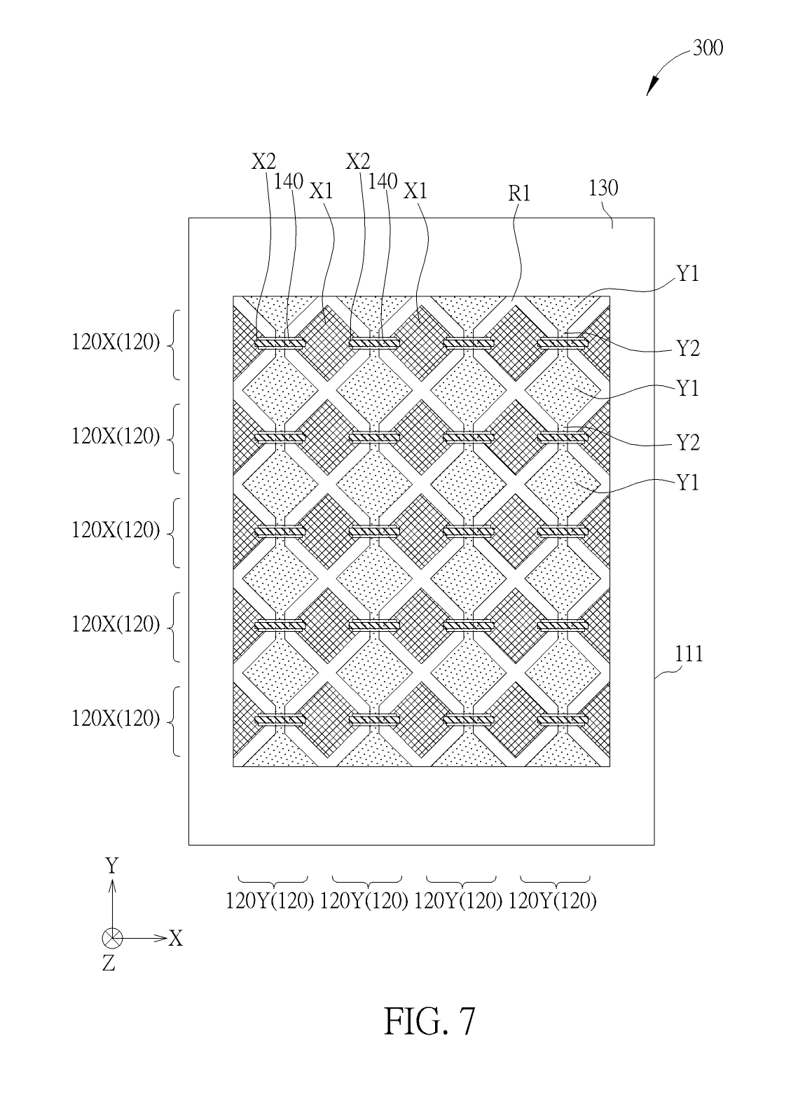

Referring to FIG. 4 and FIG. 7, FIG. 7 is a diagram illustrating a touch panel according to a third preferred embodiment of the present invention, and FIG. 4 can be regarded as a diagram illustrating a partial enlargement of the touch panel as shown in FIG. 7. As shown in FIG. 4 and FIG. 7, the present invention provides a touch panel 300. In comparison with the first preferred embodiment, the present embodiment is characterized in that the sensing electrode 120 comprises a plurality of first axis electrodes 120X and a plurality of second axis electrodes 120Y. The first axis electrodes 120X cross the second axis electrodes 120Y, and the first axis electrodes 120X and the second axis electrodes 120Y are electrically isolated from each other, to perform either the self-capacitance touching sensing or the mutual-capacitance touching sensing. Each of the first axis electrodes 120X extends along a first direction X, and each of the second axis electrodes 120Y extends along a second direction Y. The first direction X is substantially perpendicular to the second direction Y, but not limited thereto. The first axis electrodes 120X and the second axis electrodes 120Y are electrically isolated from each other. A plurality of insulation lumps 140 or insulation layer (not shown in the drawings) may be disposed at portions where the first axis electrodes 120X interlaces the second axis electrodes 120Y, but not limited thereto. Please note that, each of the first axis electrodes 120X, each of the second axis electrodes 120Y and each of the first and second axis electrodes 120X, 120Y consist of at least one part of the mesh units 120P. Precisely speaking, each of the first axis electrodes 120X includes a plurality of first sub electrodes X1 and a plurality of first connection portions X2. The first connection portions X2 are disposed between two adjacent first sub electrodes X1 respectively for electrically connecting the first sub electrodes X1. Each of the second axis electrodes 120Y includes a plurality of second sub electrodes Y1 and a plurality of second connection portions Y2. The second connection portions Y2 are disposed between two adjacent second sub electrodes Y1 respectively for electrically connecting the second sub electrodes Y1. Each first sub electrode X1, each first connection portion X2, each second sub electrode Y1, each of second connection portion Y2, or each of all aforementioned elements consists of at least one part of the mesh units 120P. In other words, each first sub electrode X1, each first connection portion X2, each second sub electrode Y1, and each second connection portion Y2 can optionally consist of the mesh units 120P according to practical requirements, and what is needed is disconnecting the mesh units 120P at particular site while defining each of the first sub electrode X1, each of the first connection portion X2, each of the second sub electrode Y1, and each of the second connection portion Y2. Therefore, the related fabrication process can be simplified accordingly, but the present invention is not limited thereto.

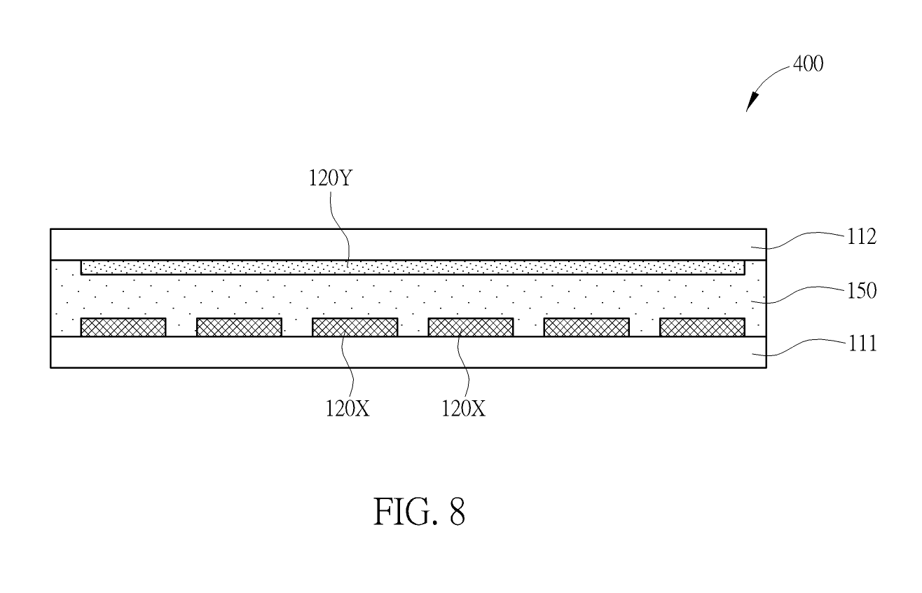

Referring to FIG. 8, FIG. 8 is a diagram illustrating a touch panel according to a fourth preferred embodiment of the present invention. As shown in FIG. 8, the present invention provides a touch panel 400. In comparison with the aforementioned third embodiment, the touch panel 400 of the present invention is characterized by further comprising a second substrate 112 opposite to the first substrate 111. The first axis electrodes 120X are disposed on the first substrate 111, and the second axis electrodes 120Y are disposed on the second substrate 112. At least one of the first substrate 111 and the second substrate 112 comprises a glass substrate, a cover lens, a plastic substrate, a flexible cover lens, a flexible plastic substrate, a thin glass substrate, or a substrate of a display device, wherein the substrate of the display device can comprise a color filter substrate of a liquid crystal display or an encapsulation substrate of an organic light-emitting display, but not limited thereto. Please note that, the first axis electrodes 120X and the second axis electrodes 120Y of the present embodiment are disposed on two opposite surface on the first substrate 111 and the second substrate 111 respectively. The first substrate 111 and the second substrate 112 may be combined by an adhesive layer 150. Preferably, the adhesive layer 150 can include optical clear adhesive (OCA), pressure sensitive adhesive (PSA), or other suitable adhesive materials.

Referring to FIG. 9, FIG. 9 is a diagram illustrating a touch panel according to a fifth preferred embodiment of the present invention. As shown in FIG. 9, the present invention provides a touch panel 500. In comparison with the aforementioned fourth embodiment, the present embodiment is characterized by disposing the second axis electrodes 120Y on a surface of the second substrate 112 which is back to the first substrate 111. Therefore, the touch panel 500 can further comprise an additional cover substrate (not shown in the drawings) optionally disposed on the second substrate 112 so as to protect the second axis electrodes 120Y, but not limited thereto.

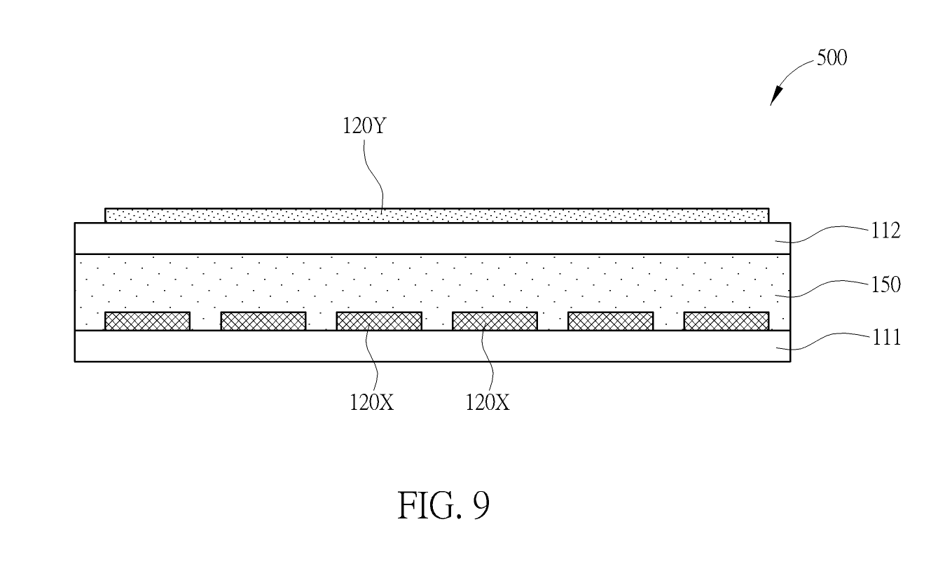

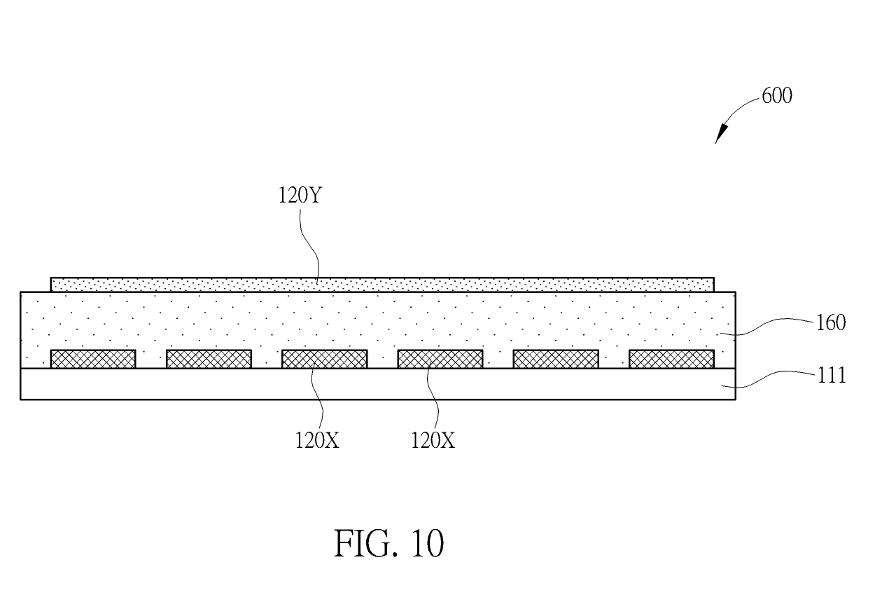

Referring to FIG. 10, FIG. 10 is a diagram illustrating a touch panel according to a sixth preferred embodiment of the present invention. As shown in FIG. 10, the present embodiment provides a touch panel 600. In comparison with the aforementioned embodiments, the touch panel 600 comprises an insulation layer 160 disposed between the first axis electrodes 120X and the second axis electrodes 120Y, for electrically isolating the first axis electrodes 120X from the second axis electrodes 120Y. The insulation layer 160 is disposed on the first substrate 111 and covers each of the first axis electrodes 120X, and the second axis electrodes 120Y are disposed on a surface of the insulation layer 160 which is back to the first axis electrodes 120X. In other words, the first axis electrodes 120X and the second axis electrodes 120Y are disposed on different surfaces of the insulation layer 160. Moreover, the touch panel 600 can further comprise a cover substrate (not shown in the drawings) optionally, to protect the second axis electrodes 120Y, but not limited thereto.

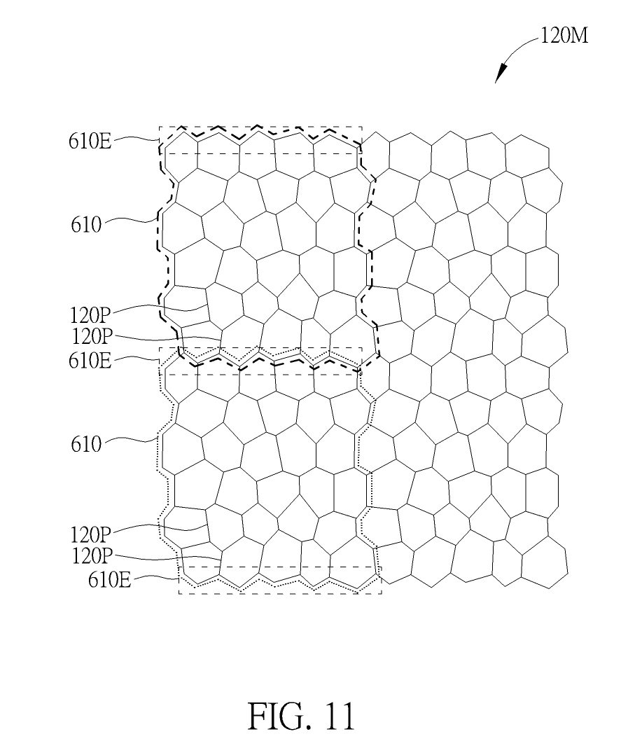

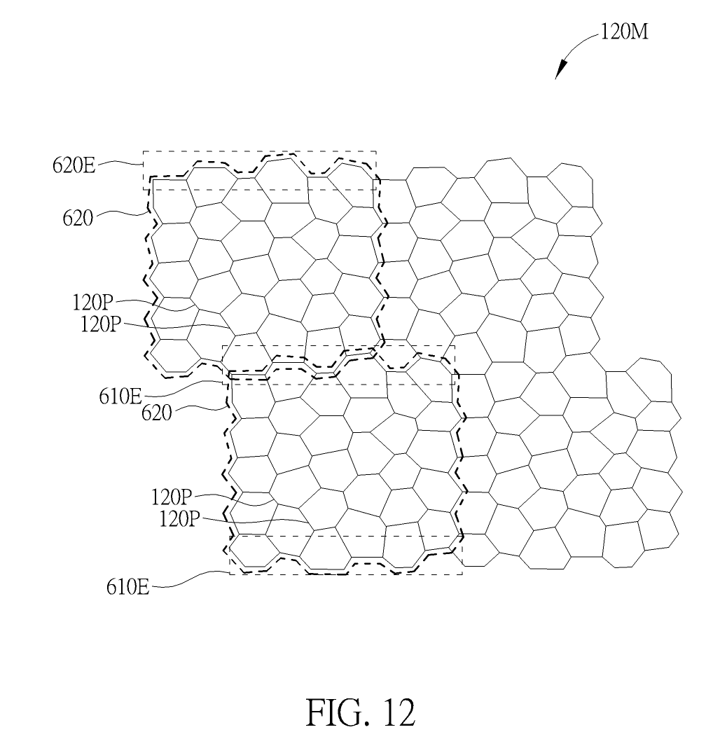

Referring to FIG. 11 and FIG. 12, FIG. 11 illustrates a mesh according to another preferred embodiment of the present invention. As shown in FIG. 11, in other preferred embodiments of the present invention, a plurality of mesh unit unions 610 consisted of a part of the mesh units 120P, and further, the mesh unit unions 610 consisted of a plurality of mesh units 120P in some area respectively (each mesh unit union 610 referring to the area surrounding by thick dotted line and dotted line as shown in FIG. 11) can be optionally formed according to practical requirement, and the mesh 120M is formed by repeatedly piecing together the mesh unit unions 610 with each other. In other words, in the touch panel of the aforementioned embodiments, at least one part of the mesh units 120P can compose the mesh unit unions 610 and each of the mesh unit unions 610 has the same shape, and the mesh unit unions 610 are adjacently disposed with each other. Please note that, at least two union side edges 610E (the union side edges 610E referring to the part surrounding by thin dotted line as shown in FIG. 11) of each mesh unit union 610 are corresponding to each other. Thus, two mesh unit unions 610 can be pieced together with each other through conjugating the corresponding union side edges 610E therebetween. Therefore, the fabrication of the mesh 120M can be easily achieved by repeatedly piecing together the mesh unit unions 610, thereby simplifying related fabrication process, such as only requiring the photomask in relatively smaller size, and saving the fabrication cost.

Referring to FIG. 12, FIG. 12 illustrates a mesh according to further another preferred embodiment of the present invention. As shown in FIG. 12, in other preferred embodiments of the present invention, a plurality of mesh unit unions 620 consisted of a part of the mesh units 120P, and further, the mesh unit unions 620 consisted of a plurality of mesh units 120P in some area respectively (each mesh unit union 620 referring to the area surrounding by thick dotted line as shown in FIG. 12) can be optionally formed according to practical requirement, and the mesh 120M is formed by repeatedly piecing together the mesh unit unions 620 with each other. Please note that, the mesh unit unions 620 are staggered arranged with some deviations, and at least two union side edges 620E (the union side edges 620E referring to the part surrounding by thin dotted line as shown in FIG. 12) of each mesh unit union 620 are partially corresponding with each other. Thus, two mesh unit unions 620 can be pieced together with each other through conjugating the partially corresponding side edges E2 therebetween. With such staggered arrangement to modify the array of repeated mesh unit unions 620, it is sufficient to reduce possible problems cause by regular arrangement of mesh unit unions 610 in the aforementioned embodiment.

Additionally, the sensing electrode of the touch panel in the aforementioned embodiments can also be fabricated from at least one part of the mesh units 120P in the mesh 120M as shown in FIG. 11 and FIG. 12 in accordance with practical requirements.

In summary, the touch panel of the present invention comprises a sensing electrode which is fabricated from those irregular mesh units, with those irregular mesh units pieced together with each other, thereby improving the problems caused by moiré effect between the touch panel and the pixel electrodes. Thus, a preferable entire visible effect can be achieved. Furthermore, the present invention also provides a method of fabricating the mesh of the touch panel, through the aforementioned method to form irregular mesh units of the touch panel.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. Touch panel, comprising:
a sensing electrode, the sensing electrode comprising a plurality of mesh units, each of the mesh units pieced together with others and being different from at least one of adjacent mesh units in shape, and each of the mesh units having a plurality of side edges connected with one another and at least two of the side edges of each mesh unit being different in length.

2. The touch panel according to claim 1, wherein each of the mesh units comprises a polygon mesh unit.

3. The touch panel according to claim 2, wherein an amount of the side edges of each mesh unit is equal to or more than three.

4. The touch panel according to claim 1, wherein one of the side edges of each mesh unit also performs as a side edge of an adjacent mesh unit.

5. The touch panel according to claim 1, wherein at least two of the side edges of each of the mesh units are different in length, and one of the two side edges is more than 5% longer than the other one.

6. The touch panel according to claim 2, wherein each of the mesh units comprises a plurality of internal angles and at least two of the internal angles of each of the mesh units are different in degree.

7. The touch panel according to claim 6, wherein one of the two internal angles is more than 5% greater than the other one.

8. The touch panel according to claim 1, wherein each of the mesh units and at least one of adjacent mesh units are different in aperture area.

9. The touch panel according to claim 8, wherein at least two of the mesh units are different in aperture area and an aperture area of one of the two mesh units is more than 5% greater than an aperture area of the other one.

10. The touch panel according to claim 1, wherein each of the mesh units is different in shape.

11. The touch panel according to claim 1, wherein a plurality of mesh unit unions consists of at least one part of the mesh units, and the mesh unit unions are identical in shape and adjacently disposed to each other.

12. The touch panel according to claim 1, further comprising:
a first substrate, wherein the sensing electrode is disposed on the first substrate.

13. The touch panel according to claim 1, wherein the sensing electrode comprises a plurality of first axis electrodes and a plurality of second axis electrodes, the first axis electrodes cross the second axis electrodes, and the first axis electrodes and the second axis electrodes 120Y are electrically isolated from each other.

14. The touch panel according to claim 13, wherein each of the first axis electrodes, each of the second axis electrodes, or each of the first and second axis electrodes consists of at least one the mesh units.

15. The touch panel according to claim 13, wherein each of the first axis electrodes comprises a plurality of first sub electrodes and a plurality of first connection portions disposed between two adjacent first sub electrodes respectively for electrically connecting the first sub electrodes, and each of the second axis electrodes comprises a plurality of second sub electrodes and a plurality of second connection portions disposed between two adjacent second sub electrodes respectively for electrically connecting the second sub electrodes.

16. The touch panel according to claim 15, wherein at least one of each of the first sub electrodes, each of the first connection portions, each of the second sub electrodes and each of the second connection portions consists of at least one of the mesh units.

17. The touch panel according to claim 13, further comprising:
a first substrate and a second substrate disposed opposite to each other, wherein the first axis electrodes are disposed on the first substrate and the second axis electrodes are disposed on the second substrate.

18. The touch panel according to claim 12, wherein the first substrate comprises a glass substrate, a cover lens, a plastic substrate, a flexible plastic substrate, a thin glass substrate, or a substrate of display device.

19. The touch panel according to claim 18, further comprising a decoration layer disposed on at least one side of the cover lens.

20. The touch panel according to claim 18, wherein the substrate of display device comprises a color filter substrate, an active matrix array substrate, or an encapsulation substrate of organic light-emitting display.

21. The touch panel according to claim 1, wherein each of the mesh units comprises at least one of aluminum, copper, silver, chromium, titanium and molybdenum, a composition layer of aluminum, copper, silver, chromium, titanium and molybdenum, an alloy of aluminum, copper, silver, chromium, titanium and molybdenum, a conductive particle, a carbon nanotube or a silver nanowire.

22. A method of fabricating a mesh of a touch panel, comprising:
providing a first mesh pattern unit, the first mesh pattern unit comprising a plurality of first side edges connected with one another, and at least two of the side edges being different in length;
drawing outward a plurality of second mesh pattern units, and each of the second mesh pattern units being drawn on a basis of one of the first side edges of the first mesh pattern unit, each of the first side edges of the first mesh pattern unit also performing as a side edge of the second mesh pattern units, and the first mesh pattern unit being different from at least one of the second mesh pattern units in shape; and
converting the first mesh pattern unit and the second mesh pattern units to a mesh.

23. The method according to claim 22, wherein the first mesh pattern unit comprises a polygon.

24. The method according to claim 22, further comprising:
drawing outward a plurality of third mesh pattern units, each of the third mesh patterns being drawn on a basis of at least one of the side edges of the second mesh pattern units, at least one of the side edges of the second mesh pattern units also performing as a side edge of the third mesh pattern units, and at least one of the second mesh pattern units being different from at least one of the third mesh pattern units in shape; and
converting the first mesh pattern unit, the second mesh pattern units and the third mesh pattern units to the mesh.

25. The method according to claim 23, wherein an amount of the first side edges is equal to or more than three.

26. The method according to claim 22, wherein at least two of the first side edges are different in length and one of the two first side edges is more than 5% longer than the other one.

27. The method according to claim 23, wherein the first mesh pattern unit comprises a plurality of internal angles and at least two of the internal angles are different in degree.

28. The method according to claim 27, wherein one of the two internal angles is more than 5% greater than the other one.

29. The method according to claim 22, wherein the first mesh pattern unit and at least one of the second mesh pattern units are different in aperture area.

30. The method according to claim 29, wherein the first mesh pattern unit and at least one of the second mesh pattern units are different in aperture area and an aperture area of one of the said first pattern unit and second pattern unit is more than 5% greater than an aperture area of the other one.

31. The method according to claim 22, wherein the first mesh pattern unit are different from the second mesh pattern units in shape.
